(19) United States
(12) Patent Application Publication
(10) Pub. No.: US 2014/0167886 A1
(43) Pub. Date: Jun. 19, 2014

(54) Plating Stub Resonance Shift with Filter Stub Design Methodology

(71) Applicant: International Business Machines Corporation, Armonk, NY (US)

(72) Inventors: Nanju Na, Essex Junction, VT (US); Nam H. Pham, Round Rock, TX (US); Lloyd A. Walls, Austin, TX (US)

(73) Assignee: INTERNATIONAL BUSINESS MACHINES CORPORATION, Armonk, NY (US)

(21) Appl. No.: 14/088,809

(22) Filed: Nov. 25, 2013

Related U.S. Application Data
(63) Continuation of application No. 13/491,873, filed on Jun. 8, 2012.

(51) Int. Cl. H01P 1/203

(52) U.S. Cl. CPC H01P 1/203
USPC 333/204

(57) ABSTRACT

A technique is provided to increase signal bandwidth of data processing signals by providing a plating stub as a filter using multiple line segments of different widths to filter the reflected high frequency components bouncing from the stub end toward the signal path. This stub-filter shifts the resonance point to a much higher frequency, placing that point of resonance beyond the bandwidth of interest without sacrificing a low frequency loss. Accordingly, there is provided an apparatus comprising a stub filter of a substrate, comprising a multi-segmented stub comprising a plurality of stub portions, where one of the stub portions has a different impedance than another of the stub portions.

This application is a continuation of U.S. patent application Ser. No. 13/491,873 filed on Jun. 8, 2012.

1. Field

The disclosure relates generally to apparatus and techniques for mitigating signal reflections for signals in a data processing system, and more specifically relates to techniques for mitigating adverse signal reflections caused by unwanted plating stubs in an electronic package.

2. Description of the Related Art

In a data processing system, as processor speeds increase there is a growing need to make improvements in electronic packaging of electrical and electronic components such that the packages themselves do not adversely influence electrical signals passing from one electrical/electronic component to another that may be housed in different packages.

For example, wire bond packages are limited in frequency bandwidth for a high speed serialization-deserialization (SerDes) application due in part to the detrimental effect of a quarter wave-length resonance effect of the plating stubs. The undesirable plating stub in the wire bond package is a by-product of the manufacturing process which requires plating of the electrodes.

For example, as generally shown by element 100 of FIG. 1, a chip die 102 (also known as an integrated circuit (IC) or integrated circuit device) is electrically connected to a wire-bond package 104 using a plurality of bond-wires 106 that connect the chip die 102 to wire-bond pads 108 on the wire-bond package 104. The wire bond pads 108 are also electrically connected to via pads or ball pads 110 of the wire-bond package 104 using signal traces 112, as is known in the art. These via pads 110 provide electrical connection to one or more wiring planes (not shown) of the wire-bond package 104. Due to current plating process techniques during the manufacturing process, an open-ended plating stub is formed, as indicated at 114. This plating stub(s) 114 may exist on the top surface, bottom surface and/or inner layers of the wire-bond package.

One method of mitigating the adverse signal-reflection effect caused by this open-ended stub is to terminate the stub with a fifty (50) ohm resister on the package carrier 104. Another stub-mitigation method is to put the terminator on the card or board that this package carrier is subsequently affixed to. Both of these terminator methods increase signal losses at low frequencies—where a majority of digital signal energy resides—as part of signal energy is tunneled to ground through the stub and the terminating resistor and hence is wasted while preventing high frequency notch at quarter-wave length resonance.

### SUMMARY

According to one embodiment of the present invention, a technique is provided to increase signal bandwidth of data processing signals by providing a plating stub as a filter using multiple line segments of different widths to filter the reflected high frequency components bouncing from the stub end toward the signal path. This stub-filter shifts the resonance point to a much higher frequency, placing that point of resonance beyond the bandwidth of interest without sacrificing a low frequency loss. Accordingly, there is provided an apparatus comprising a stub filter of a substrate, comprising a multi-segmented stub comprising a plurality of stub portions, where one of the stub portions has a different impedance than another of the stub portions.

### BRIEF DESCRIPTION OF THE SEVERAL VIEWS OF THE DRAWINGS

FIG. 1 depicts a traditional stub that exists on a wirebond package due to a currently known plating process;

FIG. 2A further depicts a traditional stub that exists on a wirebond package due to a currently known plating process;

FIG. 2B depicts an improved plating stub design that provides a stub-filter;

FIG. 3 depicts a graph of various signal characteristics for a traditional and improved plating stub;

FIG. 4 further depicts a graph of signal characteristics for various plating stub designs; plating stubs with line segment of single line width and plating stubs with various impedance ratios in two line widths segments to form a filter;

FIG. 5 (including FIG. 5A and 5B) depicts a technique for increasing impedance ratio on stub-filters routed on a surface layer as typical, with FIGS. 5A and 5B being the side and top views, respectively;

FIG. 6 (including FIG. 6A and 6B) depicts a technique for further increasing the impedance ratio of the multi-segmented stub-filter by routing on an inner layer; and

FIG. 7 depicts a conducting path for plating where a via connects a surface electrode to a multi-segmented stub-filter on an inner layer and is cut off after plating in a manufacturing and assembly process.

### DETAILED DESCRIPTION

As will be appreciated by one skilled in the art, aspects of the present invention may be embodied as a system or method. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Aspects of the present invention are described below with reference to flowchart illustrations and/or block diagrams of methods and apparatus (systems) according to embodiments of the invention.

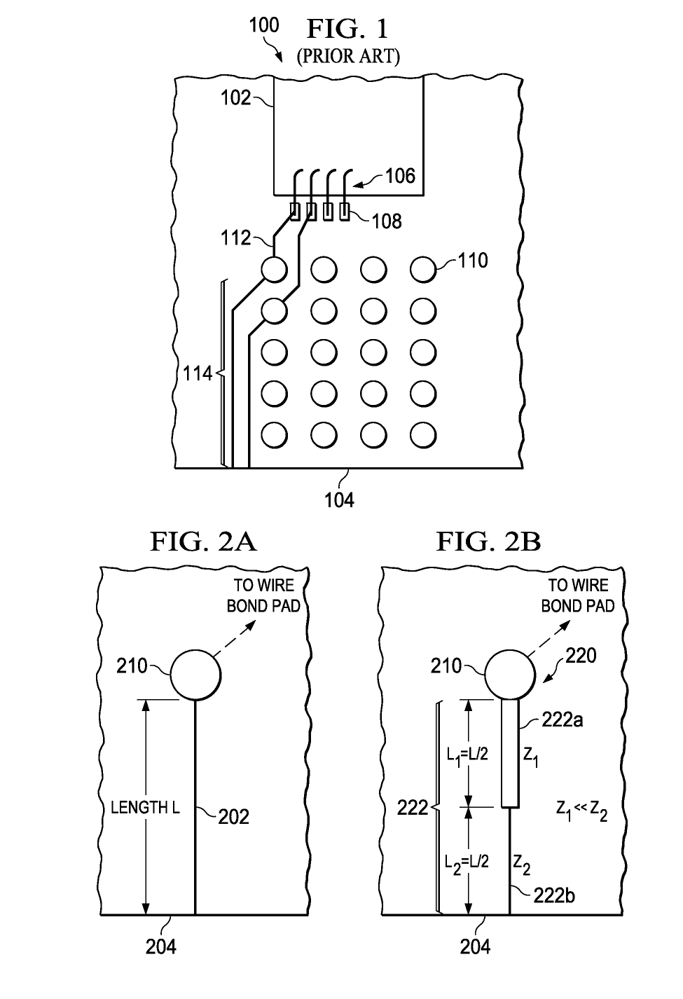

Turning now to FIG. 2A, there is depicted at 202 an example stub of a current chip carrier. This stub 202, which is the result of a manufacturing process where this signal line further extends to another portion of the substrate (not shown) that has been cut-away since it is no longer needed after testing the electronic package prior to cutting along the package substrate edge 204, has a length L (varying with signal junction locations, typically vias or ball pads) and an associated line width for a typical fifty (50) ohm characteristic impedance equal to the impedance of signal lines. The stub 202 extends from this package substrate edge 204 to element 210, which is a via pad if stub 202 is on a top surface or inner layer of the package, and is a ball-grid-array (BGA) ball pad if stub 202 is on a bottom surface of the package. Also indicated in FIG. 2A is an electrical connection to a wire bond pad, such as element 108 of FIG. 1.

Though a wire-bond package of a very common BGA type is used to state/describe the method of this invention, note that the method applies to other wire-bond package types of electro-plating as well. Stub shall be considered from open end of extended conductor to a conductor node of signal path in such packages.

FIG. 2B shows an embodiment of the present invention at 220 that has improved on this electrical interconnect scheme depicted in FIG. 2A. Specifically, a stub filter 222 is provided, which in the preferred embodiment comprises two distinct portions 222a and 222b. This stub filter is a conductive path between the package substrate edge 204 and the via pad or BGA ball pad 210. Each of these portions 222a and 222b has a line width that is different from the other respective portion. For example, portion 222a is substantially thicker than portion 222b to realize different characteristic impedances on 222a and 222b. While the respective lengths of each portion 222a and 222b can be different for any improvement, the optimal filtering effect is achieved when the lengths of two segments are the same with each being ½ of the overall stub length of L that is depicted in FIG. 2A. As will be further shown below, higher bandwidth improvement is achieved with higher impedance ratio of the second line segment to the first line segment Z₂:Z₁. While the impedance ratio can be controlled by manipulating the relative line widths of these stub-filter segments/portions 222a and 222b, there is a line width control limit due to manufacturing and design space constraints. Further improvement techniques for ratio increase are suggested as examples later herein.

Providing two separate and distinct stub portions by the stub filter 222 effectively provides two transmission line segments with different impedances. For example, stub filter portion 222a has an impedance of Z₁ that is determined by geometrical dimensions (line width, line thickness, distance to reference layer conductor) and material characteristics (conductor, insulating material) surrounding 222a. Stub filter portion 222b has an impedance of Z₂ that is similarly determined by dimensions and materials surrounding 222b. Since the material sets and line thickness are common to 222a and 222b in typical packages, line width and distance to neighboring conductors in particular ground reference conductor will determine the impedance difference. As it is desired that the impedance of portion 222a Z₁ be substantially less than the impedance of portion 222a Z₂, line portion 222a is designed for higher capacitance with lower inductance while line portion 222b is designed for lower capacitance and higher inductance. In doing so, this periodic structure of the stub alters refection behavior along the stub and effectively shifts resonance frequency to a higher range.

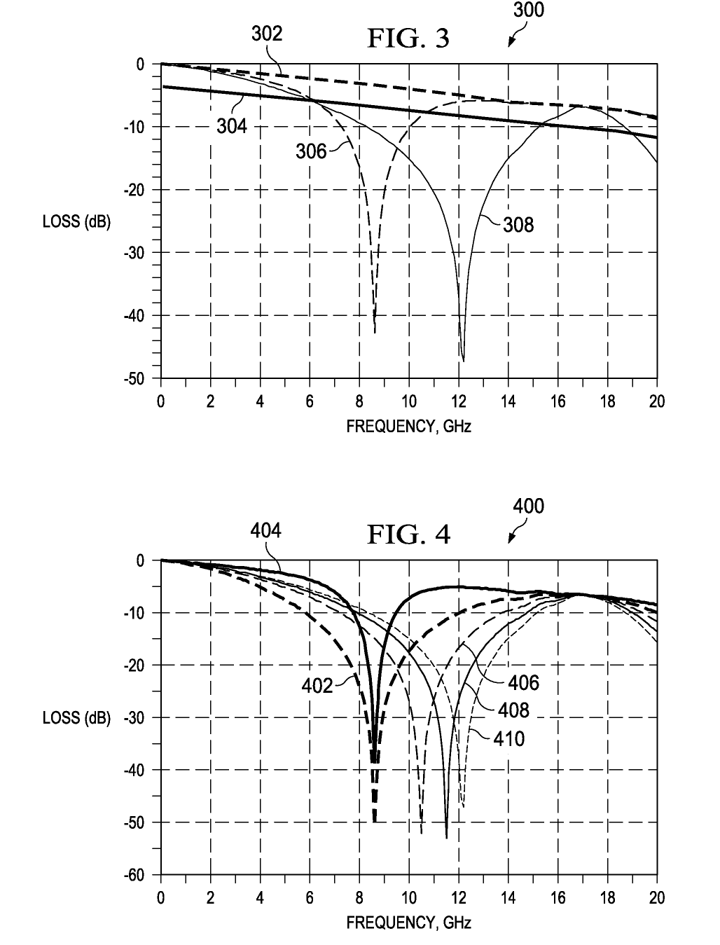

Various representative frequency responses of transmission behavior on an interconnect from chip pad to wire-bond pad are shown by graph 300 in FIG. 3. Signal 302 shows the frequency characteristics/loss if there were no plating stub at all, meaning no undesirable resonance caused by stub reflections. Signal 306 shows the signal transmission characteristic of typical wire-bond package design having a plating stub, such as stub 202 of FIG. 2A, in the middle of signal path, in which a deep notch characterizes abrupt signal loss at the frequency region around 8.5 GHz with impact on a broad range of high frequencies ˜6 to 11 GHz. Signal 304 shows the frequency response using a termination technique in a prior art where plating stubs are terminated with resistors of signal line impedance. While this technique removes deep notch from the stub resonance, it causes a significant signal loss at low frequencies carrying a majority of signal energy.

When using the stub-filter mechanism that is disclosed herein, a resulting signal transmission characteristic curve for a stub design with a Z₁:Z₂ ratio of 1:4 is shown at 308 as an example, where the signal loss does not begin to dramatically drop until approximately 8-10 GHz, with the even more pronounced signal loss occurring around 12 GHz. Thus, the use of the stub-filter has shifted the adverse stub-induced signal characteristics to a higher frequency range, placing that point of resonance beyond the bandwidth of interest without sacrificing a low frequency loss.

FIG. 4 further illustrates in graph 400 the effects of different Z₁:Z₂ impedance ratios of the current stub-filter design as shown in 406, 408 and 410 while also comparing the effect of stub design method per another prior art disclosure shown in 404. Loss characteristics in 402 for stub line impedance 80 ohm and 404 for stub line impedance 20 ohm are compared to highlight a method in a prior art where characteristic impedance of the stub is controlled by varying line width for the whole stub line segment as a way of improving frequency response around resonance frequency. The limitation with this prior art is that the notch frequency at resonance is fixed and the bandwidth cannot be extended further despite loss improvement at frequency region toward the notch frequency. As per the stub-filter techniques disclosed herein, signal 406 represents characteristics when using a stub-filter with a Z₁:Z₂ ratio of 1:2, signal 408 represents characteristics when using a stub-filter with a Z₁:Z₂ ratio of 1:3, and signal 410 represents characteristics when using a stub-filter with a Z₁:Z₂ ratio of 1:4, depicting larger shift of resonance with higher impedance ratio of stub filter design using the techniques provided herein. As observed in loss curves 406-410 compared to those in 402-404, the design technique provided herein provides superior improvement to the prior art.

Thus, while maintaining the same overall stub length, such as L that is shown in FIG. 2A and L₁+L₂=L as shown in FIG. 2B, stubs are designed with at least two characteristic impedances on divided line segments. The first line segment L₁, due to its lower impedance, provides a relatively capacitive impedance (Z₁), whereas the second line segment L₂, due to its higher impedance, provides a relatively inductive impedance (Z₂)—thereby developing a filter characteristic on periodic capacitive line and inductive line combination, with Z₁<Z₂. A higher resonance shift is achieved with a larger impedance ratio Rz=Z₂/Z₁, which typically is achieved with lower impedance of Z₁ on wider traces and higher impedance of Z₂ on narrower traces.

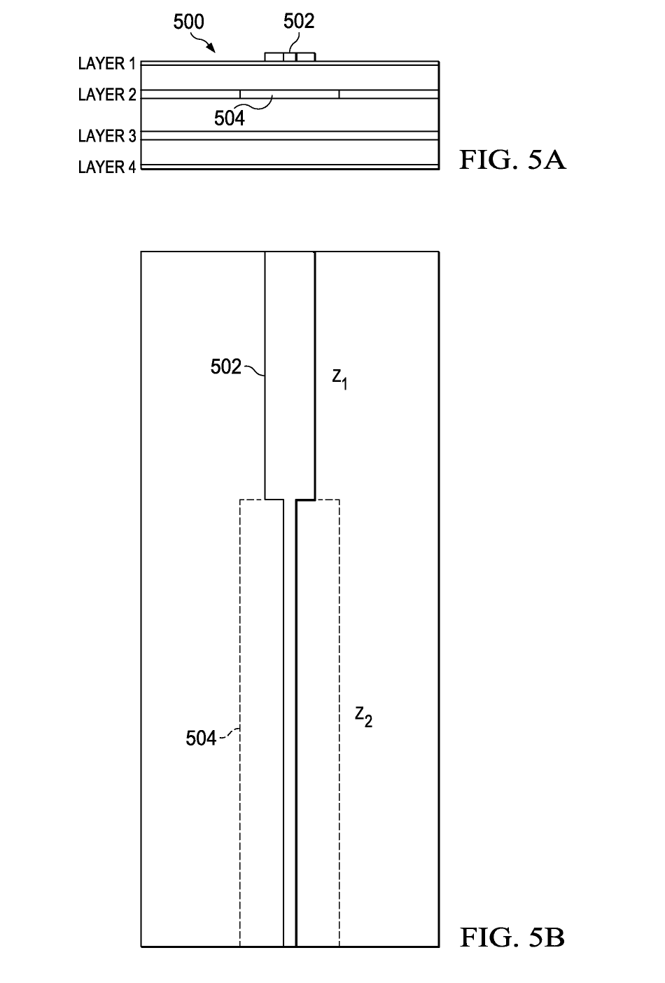

While such desired impedance control for the stub-filter may be limited by manufacturing minimum line width and design routing space on the substrate, higher impedance of Z₂ can be achieved by removing a ground layer(s) conductor under the stubs on the surface layer. This can be seen in FIG. 5, where a four (4) layer substrate is shown at 500 with a multi-segmented stub filter 502 on the top surface (Layer 1). A portion of a conductor Layer 2 has been cut-away beneath the Z₂ portion (element 222b of FIG. 2B) of the stub-filter on the top surface, as shown by element 504 in both the side view and top view depicted in FIG. 5. If the stub-filter is formed on the bottom surface (Layer 4), a similar removal of a conductor portion in Layer 3 would achieve a corresponding increase in the Z₂ impedance for such a bottom surface stub filter. As dielectric constant of insulating material and distance between layers impact impedance of the lines as well, further tuning is possible while those parameters are common to both line segments of the stub filter 502.

Thus, illustrative embodiments of the present invention provide a technique to increase signal bandwidth of data processing signals by providing a stub as a filter using multiple line segments of different widths to produce different impedances. This stub-filter shifts the resonance point to a much higher frequency, placing that point of resonance beyond the bandwidth of interest without sacrificing a low frequency loss.

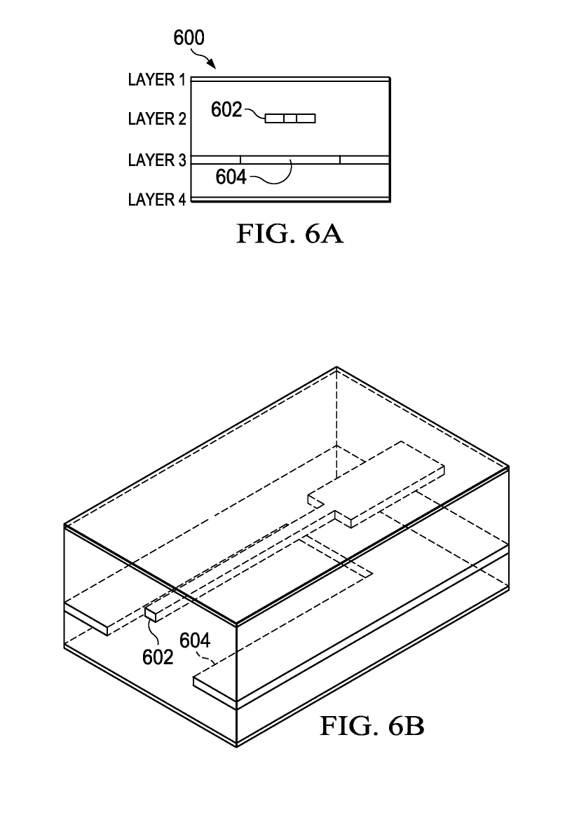

Increases to Rz are also achievable by lowering the impedance of Z₁. Such Z₁ impedance lowering may be achieved by routing the plating stub (and specifically, the stub-filter as provided herein) on inner substrate layers. For example, as shown in FIG. 6, here there is again shown a four (4) layer substrate at 600. In this example, the plating stub in accordance with a preferred embodiment is routed on an inner layer of the multi-layered substrate, and in this particular example it is routed on inner Layer 2 as shown by element 602. In this scenario, conductive material below line segment L₂ of this plating stub/stub-filter is removed in Layer 3 as depicted by element 604. Removing the conductive material below line segment L₂, but keeping the conductor below line segment L₁ of stub-filter 602 effectively increases the impedance ratio Rz by realizing lower impedance with more capacitance on line segment L₁ and higher impedance with more inductance on line segment L₂.

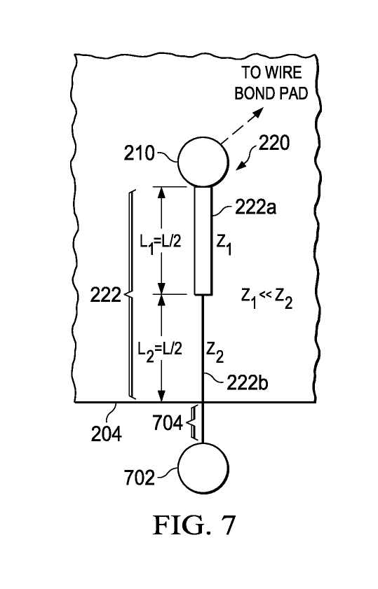

FIG. 7 shows a way of forming a conducting path for plating through a via to the stub-filter 222 routed on an inner layer as in FIG. 6. Electrode contact node for plating is typically formed on the surface along the traces 704 as an extension of stub traces 222b at the final substrate edge 204 for stub filters routed on a surface layer as in FIG. 5. Since the stub filter traces in FIG. 6 are routed on an inner layer, a conducting path between inner layer traces and a surface electrode contact node is formed though vias 702 on a panel side which will be cut away at the final manufacturing and assembly process.

It is noted that the above described impedance changes to increase the impedance ratio could be accomplished using alternative techniques, such as using different materials. For example, a high dielectric constant material could be used in the L1 area and a low dielectric constant material could be used in the L2 area. As another example, a different layer arrangement of the L1 and L2 segments could be used with associated dielectric thickness layers to effectuate changes in impedance to increase the impedance ratio.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for mitigating signal reflections caused by a plating stub by using a multi-segmented stub filter having a plurality of segments each having a different width to shifting a resonant frequency of an electrical signal propagated on the plating stub.

2. The method of claim 1, wherein the plurality of segments each have a different characteristic impedance, respectively, to effectuate the shifting a resonant frequency of an electrical signal propagated on the plating stub.

3. A method for mitigating signal reflections caused by a plating stub extending from an edge of an electrical carrier to a pad of the electrical carrier, comprising:
forming a first portion of the plating stub; and
forming a second portion of the plating stub, wherein the first portion has a different width than the second portion.

4. The method of claim 3, where the first portion has a different impedance than the second portion

4. The method of claim 4, wherein the first portion has a first impedance and the second portion has a second impedance, and wherein an impedance ratio of the first impedance with respect to the second impendence is approximately 1:4.

5. The method of claim 3, further comprising:
removing a portion of a ground layer conductor under at least one of the first portion and second portion.

6. The method of claim 3, further comprising:
removing a portion of a ground layer conductor above at least one of the first portion and second portion.

7. The method of claim 3, wherein the first portion and the second portion of the plating stub are formed on the electrical carrier.

8. The method of claim 3, wherein the electrical carrier is a multi-layer electrical carrier, and the first portion and the second portion of the plating stub are formed on an inner layer of the multi-layer electrical carrier.
